(19) United States
(12) Patent Application Publication
(10) Pub. No.: US 2007/0210708 A1
(43) Pub. Date: Sep. 13, 2007

(54) Light-Emitting Element and Display Apparatus

(76) Inventors: Massayuki Ono, Osaka (JP); Shogo Nasu, Hyogo (JP); Toshiyuki Aoyama, Osaka (JP); Masaru Odagiri, Hyogo (JP)

Correspondence Address: MCDERMOTT WILL & EMERY LLP, 600 13TH STREET, N.W., WASHINGTON, DC, 20005-3096, US

(21) Appl. No.: 11/628,770

(22) PCT Filed: Jun. 3, 2005
(86) PCT No.: PCT/JP05/10245

§ 371 Date: Dec. 7, 2006

(30) Foreign Application Priority Data
Jun. 7, 2004 (JP) 2004-168303

(51) Int. Cl. H01J 1/62

(52) U.S. Cl. 313/509

(57) ABSTRACT

A light-emitting element is provided with: a pair of plate electrodes at least one of which is transparent or translucent; a light-emitting layer containing an inorganic phosphor, which is sandwiched between the electrodes; and at least one layer of a dielectric layer made from a ferroelectric polymer material, which is sandwiched between the electrodes in addition to the light-emitting layer.

### BACKGROUND

1. Technical Field

The present invention relates to a display apparatus in which an electroluminescence (hereinafter, simply abbreviated as EL) element is used.

2. Description of the Related Art

In recent years, among various types of flat display apparatuses, those display apparatuses using an electroluminescence element have received much attention as prospective apparatuses. The display apparatus using this EL element, which has a self-light-emitting property, is characterized by its superior visibility, wide viewing angle and fast response time. Here, the EL elements which have been currently developed are classified into an inorganic EL element using an inorganic material as a light-emitting material and an organic EL element using an organic material as a light-emitting material.

In the case of the inorganic EL element using an inorganic phosphor such as zinc sulfide as a light-emitting material, electrons accelerated by an electric field as high as 10⁶ V/cm, collide with luminescent centers of the phosphor to excite them so that light is emitted when they are alleviated. The inorganic EL elements are classified into a dispersion type EL element having a structure in which phosphor powder is dispersed in a polymer organic material or the like, with electrodes being formed upper and lower sides thereof, and a thin-film type EL element having a structure in which two dielectric layers and a thin-film light-emitting layer sandwiched by the dielectric layers are placed between a pair of electrodes. Although the dispersion type EL element is easily formed, its luminance is low and its service life is also short; therefore, the applications thereof have been limited. In the thin-film type EL element, on the other hand, those elements having a double insulation structure, proposed by Inoguchi et al. in 1974, have high luminance and a long service life, and have been put into practical use as displays and the like for use in vehicles. Moreover, an inorganic EL element, which uses an insulating ceramic substrate as a substrate, with one of dielectric layers forming the double insulation structure being formed as a thick film dielectric layer, has been known (Japanese Patent Publication No. 7-44072). This inorganic EL element makes it possible to suppress dielectric breakage at the time of driving, which is caused by pinholes resulting from dusts and the like during the manufacturing process.

Referring to FIG. 7, the following description will discuss a conventional inorganic EL element. FIG. 7 is a cross-sectional view perpendicular to the light-emitting face of an EL element in which a thick film dielectric material is used. This EL element 60 has a structure in which an opposing electrode 12, a thick-film dielectric layer 61, a light-emitting layer 14 and a transparent electrode 15 are stacked on a substrate 11 in this order. Light emission is taken out from the transparent electrode 15 side. The thick-film dielectric layer 61 has a function for regulating an electric current flowing through the thin-film light-emitting layer 14 so as to suppress dielectric breakage of the EL element 60 and also to provide a stable light-emitting property. Here, a display apparatus of a passive matrix driving system has been known in which: opposing electrodes 12 and transparent electrodes 15 are patterned into a stripe format so as to be made orthogonal to each other, and a desired pattern display is carried out by applying a voltage to a specific pixel selected in the matrix.

With respect to the dielectric material to be used as the thick film dielectric layer 61, those materials having a high dielectric constant with high insulating resistance and dielectric strength are preferably used, and in general, dielectric materials having a perovskite structure, such as Y₂O₃, Ta₂O₃, Al₂O₃, Si₃N₄, BaTiO₃, SrTiO₃, PbTiO₃, CaTiO₃ and Sr(Zr, Ti)O₃, are used. Each of these dielectric materials is formed into fine particles, and dispersed in an organic polymer matrix to be made into a paste state, and then film-formed by using a thick-film printing method. Moreover, with respect to the inorganic phosphor to be used as the light-emitting layer 14, in general, a material which has an insulator crystal as a host crystal doped with an inorganic material serving as a luminescent center is used. Since this host crystal used is stable in physical and chemical properties, the inorganic EL element is highly reliable, and achieves a service life exceeding 30,000 hours. For example, a light-emitting layer, mainly composed of ZnS doped with a transition metal element and a rare-earth element, such as Mn, Cr, Tb, Eu, Tm and Yb, is used so that the light-emitting luminance is improved (Japanese Patent Publication No. 54-8080).

Moreover, in order to minimize the occurrence of cracks or the like upon firing the thick-film dielectric layer, a lead-based dielectric material having a comparatively low firing temperature is sometimes used (Japanese Patent Laid-open Publication No. 7-50197).

### SUMMARY OF THE INVENTION

In order to provide desired characteristics to the thick-film dielectric layer 16, a high-temperature firing process is required after the film-forming process. For this reason, a quartz substrate and a ceramic substrate having a heat resistant property are used as the substrate 11. However, due to a difference in thermal expansion coefficients between the dielectric material and the substrate material, irregular dispersion in the organic polymer matrix and the like, surface defects, such as cracks, are caused in the dielectric layer upon firing, resulting in problems such as a reduced dielectric strength property.

Here, the occurrence of cracks in the dielectric layer can be suppressed by using the above-mentioned lead-based dielectric material that allows a low-temperature firing process so that the low-temperature firing is conducted; however, the use of lead that is toxic to the human body as the material is not preferable from the viewpoints of production and applications.

The objective of the present invention is to provide an EL element that provides high luminance and is safe and inexpensive, and a display apparatus using such an EL element.

A light-emitting element in accordance with the present invention is characterized by including: a pair of electrodes at least one of which is transparent or translucent; a light-emitting layer containing an inorganic phosphor, which is sandwiched between the electrodes; and at least one layer of a dielectric layer made from a ferroelectric polymer material, which is sandwiched between the electrodes in addition to the light-emitting layer.

Here, preferably, the dielectric layer is mainly composed of a ferroelectric polymer material having an amount of residual polarization of 4 μC/cm² or more. Moreover, the ferroelectric polymer material may be prepared as a fluorine-based polymer material.

Moreover, the light-emitting layer may have a structure in which inorganic phosphor fine particles are dispersed in a binder. Alternatively, the light-emitting layer may be an inorganic phosphor thin film. The light-emitting layer preferably has a thickness of 1/20 or more of the thickness of the dielectric layer.

Furthermore, the light-emitting element may further include a supporting substrate that is made in contact with at least one of the electrodes and supports the electrode. The supporting substrate may be prepared as a glass substrate. Moreover, the supporting substrate may be a transparent resin substrate having flexibility.

A display apparatus in accordance with the present invention is characterized by including: a light-emitting element array in which the above-mentioned light-emitting elements are two-dimensionally arranged; a plurality of x electrodes that are extended in parallel with one another in a first direction in parallel with the light-emitting face of the light-emitting element array, and a plurality of y electrodes that are extended in parallel with one another in a second direction that is orthogonal to the first direction in parallel with the light-emitting face of the light-emitting element array.

In accordance with the EL element and display apparatus of the present invention, since a ferroelectric polymer material having an amount of residual polarization of 4 μC/cm² or more is used for the dielectric layer, light emission with high luminance is available. Moreover, since dielectric fine particles are not used, neither a firing process nor a dispersing process into an organic polymer matrix is required so that the manufacturing process can be carried out with a high yield, thereby making it possible to cut substrate costs and production costs. Moreover, since no lead-based dielectric material is required, it becomes possible to provide an EL element and a display apparatus that ensure safety to the human body and are inexpensive and superior in reliability.

### BRIEF DESCRIPTION OF THE DRAWINGS

The present invention will become readily understood from the following description of preferred embodiments thereof made with reference to the accompanying drawings, in which like parts are designated by like reference numeral and in which:

FIG. 1 is a cross-sectional view perpendicular to a light-emitting face of an EL element in accordance with a first embodiment of the present invention;

FIG. 2 is a cross-sectional view perpendicular to a light-emitting face of an EL element in accordance with a second embodiment of the present invention;

FIG. 3 is a cross-sectional view perpendicular to a light-emitting face of an EL element in accordance with a third embodiment of the present invention;

FIG. 4 is a cross-sectional view perpendicular to a light-emitting face of another example of an EL element in accordance with the third embodiment of the present invention;

FIG. 5 is a perspective view that shows a display apparatus in accordance with a fourth embodiment of the present invention;

FIG. 6 is a graph that shows a hysteresis characteristic of an organic ferroelectric material; and

FIG. 7 is a cross-sectional view perpendicular to a light-emitting face of an EL element of the prior art.

### BEST MODE FOR CARRYING OUT THE INVENTION

Referring to attached drawings, the following description will discuss an EL element in accordance with embodiments of the present invention and a display apparatus using such an EL element. Here, in the drawings, those members having virtually the same structures are indicated by the same reference numerals.

### First Embodiment

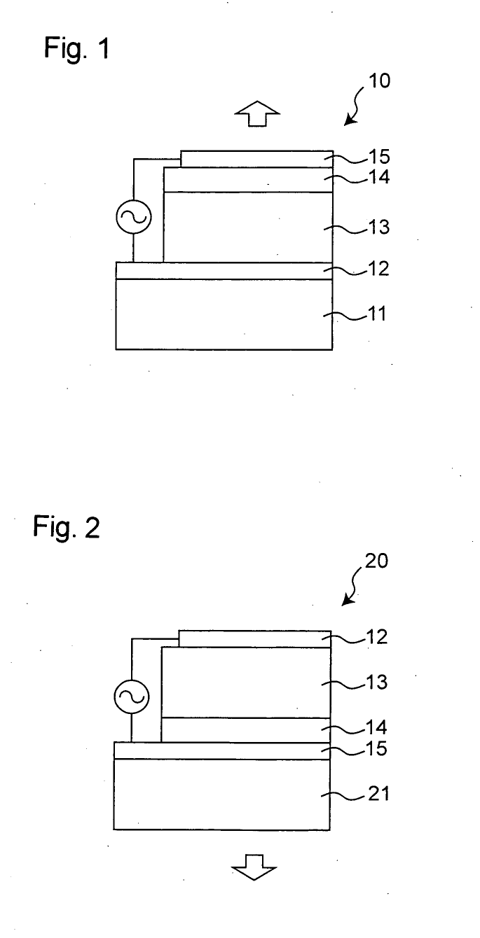

Referring to FIG. 1, the following description will discuss an EL element in accordance with a first embodiment of the present invention. FIG. 1 is a cross-sectional view perpendicular to a light-emitting face of an EL element 10. This EL element 10 is provided with a dielectric layer 13 made from a ferroelectric organic material and a light-emitting layer 14 containing an inorganic phosphor material. More specifically, this EL element 10 has a structure in which an opposing electrode 12, a dielectric layer 13, a light-emitting layer 14 and a transparent electrode 15 are successively stacked on a substrate 11. Light emitted from the inorganic phosphor is taken out from the transparent electrode 15 side. Here, in addition to the above-mentioned structure, a structure used for sealing the entire portion or one portion of the EL element 10 may be prepared. With this structure, the moisture resistant property of the inorganic phosphor is improved so that the element service life can be prolonged. Moreover, the opposing electrode 12 may have a black color. Furthermore, a pigment or the like having a black color may be contained in the dielectric layer 13. With this arrangement, it becomes possible to prevent external light that has been made incident onto the EL element from the transparent electrode 15 side from reflecting on the surface of the opposing electrode 12, and consequently to provide a superior external light contrast.

Next, the following description will discuss respective constituent members of the EL element 10 in detail.

First, the substrate 11 will be explained. With respect to the substrate 11, any material may be used as long as it can support respective layers to be formed thereon, and has a high electric insulating property. Preferably, the material is superior in adhesion to the opposing electrode 12. With respect to the substrate 11, a glass substrate such as Corning 1737 or the like may be used; however, the present invention is not intended to be limited by these materials. In order to prevent alkaline ions or the like contained in normal glass from giving adverse effects to the light-emitting element, non-alkaline glass or soda lime glass, coated with alumina or the like on its glass surface as an ion barrier layer, may be used. Moreover, a resin film such as a polyester film may also be used. With respect to the resin film, those materials that are superior in endurance, flexibility, electric insulation and moisture resistance are preferably used, and, for example, a combination between a polyethylene terephthalate-based resin or a polychloro-trifluoroethylene-based resin and a nylon 6, and a fluororesin-based material may be used. Moreover, a metal substrate bearing an insulating layer on its surface, a ceramics substrate, a silicon wafer or the like may be used.

The following description will discuss the opposing electrode 12. With respect to the opposing electrode 12, not particularly limited, any material may be used as long as it has a conductive property. Preferably, the material is superior in adhesion to the substrate 11 and the dielectric layer 13. Preferable examples thereof include: metal oxides, such as ITO, SnO₂ and ZnO, metals such as Au, Ag, Al, Cu, Ni, Pt, Pd, Cr, Mo, W, Ta and Nb, polymer materials, such as polyaniline, polypyrrole, PEDOT/PSS, and carbon.

Next, the following description will discuss the dielectric layer 13. With respect to the dielectric layer 13, a polymer-based organic material having a high electric insulating property and a ferroelectric property is used (hereinafter, referred to as “organic ferroelectric material”). Preferably, this organic ferroelectric material is superior in adhesion to the dielectric layer 13 and the transparent electrode 15. Moreover, it is preferably prepared as a material that is less likely to have inclusion of impurities and foreign matters causing pinholes and defects, and easily provides uniform film thickness and film quality. In particular, preferable examples of the organic ferroelectric material include: polyvinylidene fluoride (PVDF), a copolymer (P (VDF/TrFE)) of vinylidene fluoride and ethylene trifluoride, a ternary copolymer (P (VDF/TrFE/HFP) of vinylidene fluoride, ethylene trifluoride and propylene hexafluoride, a copolymer (P (VDF/TeFE)) of vinylidene fluoride and ethylene tetrafluoride, a vinylidene fluoride oligomer, polyvinyl fluoride (PVF), a copolymer (P (VF/TrFE)) of vinyl fluoride and ethylene trifluoride, polyacrylonitrile (PAN), and a copolymer (P (VDCN/VAc)) of vinylidene cyanide and vinyl acetate; however, the material is not particularly limited by these. Each of these organic ferroelectric materials has a structure in which a polarization inversion takes place due to rotations of individual molecule chains caused by an elementary process of a conformation change in a molecule chain that is continuously connected long through covalent bonds. Moreover, although these organic ferroelectric materials require a comparatively strong electric field for polarization inversion, they easily provide a thin film since they are polymer-based organic materials, and are free from defects such as cracks, which are often caused by ceramic-based materials; thus, it becomes possible to provide a dielectric layer that is superior in the insulating property.

Referring to FIG. 6, the following description will discuss a hysteresis characteristic of this dielectric layer 13. FIG. 6 is a graph that shows a relationship between the amount of polarization P of a dielectric layer and the intensity E of electric field applied to the dielectric layer, and thus indicates the hysteresis characteristic of the dielectric layer. Electrodes are attached to the two surfaces of a dielectric layer, and by applying an AC voltage across these electrodes, the orientation of each of dipoles inside the dielectric layer is aligned in the electric field direction so that a polarization as the entire dielectric layer is caused (state A). Next, at the time when the applied electric field has reached zero also, the polarization state is maintained (state B). The amount of polarization at this time is referred to as the amount Pr of residual polarization. When an electric field in the reverse direction is further applied, the reverse direction polarization is saturated (state C), and even after the applied electric field has been set to zero, the amount of residual polarization in the reverse direction remains (state D).

The inventors of the present invention have found that by preparing a dielectric layer 13 made from an organic ferroelectric material having an amount of residual polarization greater than 4 μC/cm², an EL element and a display apparatus that have high luminance can be obtained. In other words, in the hysteresis characteristic (shown in FIG. 6) of an organic ferroelectric material, as the amount Pr of residual polarization becomes greater, the inner polarization is caused by a charge accumulated in the level of light-emitting layer/dielectric layer interface of the EL element to increase the effective electric field intensity, thereby improving the light-emitting luminance.

With respect to the film-forming method of the dielectric layer 13, after the organic ferroelectric material has been dissolved in a desired organic solvent or the like, a known solvent casting method, such as an ink-jet method, a dipping method, a spin coating method, a screen printing method and a bar-coating method, can be used. Moreover, another film-forming method, such as a vapor deposition polymerization method and an LB method, may be used. However, the film-forming method of the dielectric layer 13 is not particularly limited by these methods.

Next, the following description will discuss the light-emitting layer 14. With respect to the light-emitting layer 14, although not particularly limited, conventionally known phosphors, such as compounds between Group 12 and Group 16, typically represented by the aforementioned ZnS doped with Mn, may be used. Other preferable examples for the host material for the phosphor include: compounds between Group 12 and Group 16, such as ZnSe, ZnTe, CdS and CdSe; phosphors of compounds between Group 2 and Group 16, such as CaS, SrS, CaSe and SrSe; mixed crystals of the above-mentioned compounds, such as ZnMgS, CaSSe and CaSrS, or mixtures thereof that may have partial segregation; thiogallate-based phosphors, such as CaGa₂S₄, SrGa₂S₄ and BaGa₂S₄; thioaluminate phosphors such as CaAl₂S₄, SrAl₂S₄ and BaAl₂S₄; metal oxide phosphors, such as Ga₂O₃, Y₂0₃, CaO, GeO₂ and SnO₂; or multi-oxide phosphors, such as Zn₂SiO₄, Zn₂GeO₄, ZnGa₂O₄, CaGa₂O₄, CaGeO₃, MgGeO₃, Y₄GeO₈, Y₂GeO₅, Y₂Ge₂O₇, Y₂SiO₅, BeGa₂O₄, Sr₃Ga₂O₆, (Zn₂SiO₄—Zn₂GeO₄), (Ga₂O₃—Al₂O₃), (CaO—Ga₂O₃) and (Y₂O₃—GeO₂). Each of these phosphors is activated by at least one kind of element selected from the group of metal elements consisting of Mn, Cu, Ag, Sn, Pb, Pr, Nd, Sm, En, Tb, Dy, Ho, Er, Tm, Yb, Ce, Ti, Cr and Al. Moreover, with respect to the activating substance, non-metal elements, such as Cl and I, and fluorides, such as TbF₃ and PrF₃, may be used. Here, two or more kinds of the above-mentioned activating substances may be activated simultaneously.

The light-emitting layer 14 may be an inorganic phosphor thin film mainly composed of the above-mentioned phosphor, or may be prepared as a layer formed by dispersing fine particles mainly composed of the above-mentioned phosphor in an organic polymer material that forms a binder. With respect to the organic polymer material, for example, cyanoethyl cellulose, polyvinylidene fluoride or the like may be used.

Moreover, the inventors of the present invention have found that by setting the film thickness of the light-emitting layer 14 to 1/20 or more of the film thickness of the dielectric layer 13, an EL element and a display apparatus having high luminance can be obtained. The following description will discuss the relationship of film thicknesses between the dielectric layer and the light-emitting layer. In general, the organic ferroelectric material is characterized by having a higher coercive electric field (corresponding to Ec in FIG. 6) in comparison with the ceramic-based ferroelectric materials. For example, in the case of an EL element using an organic ferroelectric material having a coercive electric field of 50 MV/m, when the film thickness of the dielectric layer exceeds 4 μm, a high voltage of about 200V is required for its polarization-inverting process. Here, when the film thickness of the dielectric layer is thin, a problem of an insulation dielectric strength arises due to adverse effects from defects and the like. In the EL element, in order to allow light emission within a range of a practical voltage application, and also to ensure a good dielectric strength, the film thickness of the dielectric layer is preferably set in a range from 1 μm to 10 μm, particular preferably, from 2 μm to 5 μm. In contrast, when the film thickness of the light-emitting layer is too thin, the light-emitting efficiency is lowered, while, when it is too thick, an increased driving voltage is required; therefore, the film thickness is preferably set in a range from 0.1 μm to 1 μm, particular preferably, from 0.2 μm to 0.5 μm. Consequently, the effect of the application of the organic ferroelectric material is obtained only in a limited range in which the film thickness of the light-emitting layer is set to 1/20 or more of the film thickness of the dielectric layer.

The following description will discuss a film-forming method for the light-emitting layer 14. In the case of the light-emitting layer 14 made of an organic phosphor thin film, the film-forming process is carried out by using a sputtering method, an EB vapor deposition method, a resistance heating vapor deposition method, a CVD method or the like. In the case of the light-emitting layer 14 formed by dispersing fine particles mainly composed of a phosphor in an organic polymer material, after dispersing and dissolving the phosphor fine particles and the organic polymer material in a desired organic solvent or the like, the film-forming process is carried out by using an ink-jet method, a dipping method, a spin-coating method, a screen printing method, a bar-coating method, or another conventionally-known solvent casting method.

The following description will discuss the transparent electrode 15. With respect to the transparent electrode 15, any material that is good in transparency is used, and the material preferably has a low resistance. Preferable examples thereof include: metal oxides, such as ITO (indium tin oxide), InZnO, SnO₂ and ZnO; however, the present invention is not intended to be limited by these. In order to improve the transparency or to lower the resistivity, ITO can be film-formed by using a known film-forming method, such as a sputtering method, an electron beam vapor deposition method and an ion plating method. Moreover, after the film-forming process, the resulting film may be subjected to a surface treatment, such as a plasma treatment, in order to control the resistivity. The film thickness of the transparent electrode 15 is determined by the sheet resistance value and the visible light transmittance that are required. Moreover, conductive resins, such as polyaniline, polypyrrole and PEDOT/PSS, may be used. Upon application of the conductive resin, a known film-forming method, such as an ink-jet method, a dipping method, a spin-coating method, a screen printing method and a bar-coating method, may be used.

Here, by preparing the opposing electrode 12 as a light transmitting electrode in the same manner as the transparent electrode 15, as well as by making the substrate 11 transparent or translucent, light emission can be obtained from both of the surfaces of an EL element.

### Second Embodiment

Referring to FIG. 2, the following description will discuss an EL element in accordance with a second embodiment of the present invention. FIG. 2 is a cross-sectional view perpendicular to a light-emitting face of an EL element 20. In comparison with the EL element 10 of the first embodiment, this EL element 20 is different in that respective electrodes and respective layers are formed on a transparent substrate 21 so that light emission is obtained from the side of the transparent substrate 21. More specifically, this structure is different in that a transparent electrode 15, a light-emitting layer 14, a dielectric layer 13 and an opposing electrode 12 are successively stacked on the transparent substrate 21.

Next, respective constituent members of the EL element 20 will be explained in detail. Here, with respect to those members that are virtually the same as those of the EL element 10 of the first embodiment, the description thereof is omitted.

With respect to the transparent substrate 21, any substrate may be used as long as it can support respective layers formed thereon. Moreover, any material may be used as long as it has a light transmittance of 80% or more in a visible light range so as to obtain light emission generated in the light-emitting layer 14, and also has a high electrical insulating property. With respect to the transparent substrate 21, for example, a glass substrate, such as Corning 1737, may be used; however, the present invention is not intended to be limited thereby. Moreover, non-alkaline glass, soda lime glass or the like may be used. Furthermore, a resin film such as polyester, may be used.

### Third Embodiment

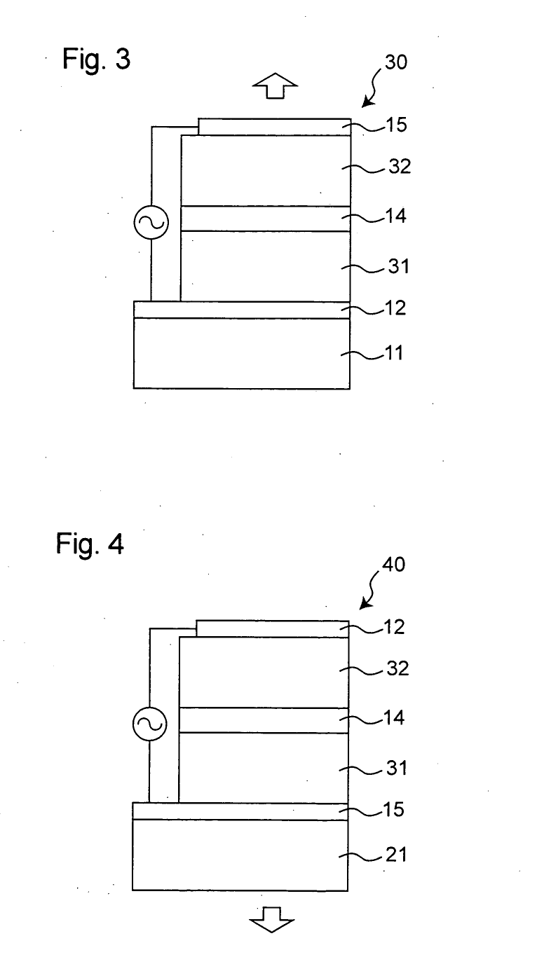

Referring to FIGS. 3 and 4, the following description will discuss an EL element in accordance with a third embodiment of the present invention. FIGS. 3 and 4 are cross-sectional views perpendicular to respective light-emitting faces of EL elements 30 and 40. In comparison with the EL element 10 of the first embodiment, this EL element 30, shown in FIG. 3, is different in that a second dielectric layer 32 is further prepared between the light-emitting layer 14 and the transparent electrode 15. More specifically, this structure is different in that an opposing electrode 12, a first dielectric layer 31, a light-emitting layer 14, a second dielectric layer 32 and an opposing electrode 15 are successively stacked on a substrate 11. With respect to the second dielectric layer 32, any material that is similar to the material for the organic ferroelectric material to be used as the first dielectric layer 31 and is transparent or translucent in a visible light range so that light emission generated inside the light-emitting layer 14 is taken out, may be used. Since this organic ferroelectric material is virtually the same as the organic ferroelectric material used for the dielectric layer 13 of the EL element 10 of the first embodiment described above, the description thereof is omitted. In comparison with the EL element 30, the EL element 40, shown in FIG. 4, is different in that respective electrodes and respective layers are stacked on a transparent substrate 21 and in that the taking-out direction of light emission (indicated by an arrow) is reversed from that of the EL element 30; however, except for these points, the EL element 40 is virtually the same as the EL element 30. Those constituent parts that are the same are indicated by the same reference numerals, and the descriptions of the respective constituent members are omitted. Here, in both of the EL elements 30 and 40 also, when an attempt is made to acquire light from both of the surfaces, the substrate 11 and the opposing electrode 12 may be made from a light-transmitting material.

In the first to third embodiments, in an attempt to acquire white-color light emission from the EL element, a method in which phosphors of two colors that are complimentary colors with each other, or of three R, G and B colors, are used, and placed in the light-emitting layer 14 in a mixed manner, or another method in which a plurality of light-emitting layers are stacked therein is proposed. Moreover, these phosphors are not necessarily required to exhibit light emission through the EL. For example, a method may be used in which: a phosphor which exhibits a blue-color EL light emission is used, and this may be combined with a phosphor or a dye that uses the blue-color light emission as the excitation source to convert the color to a green color having a longer wavelength or a red color light emission.

### Fourth Embodiment

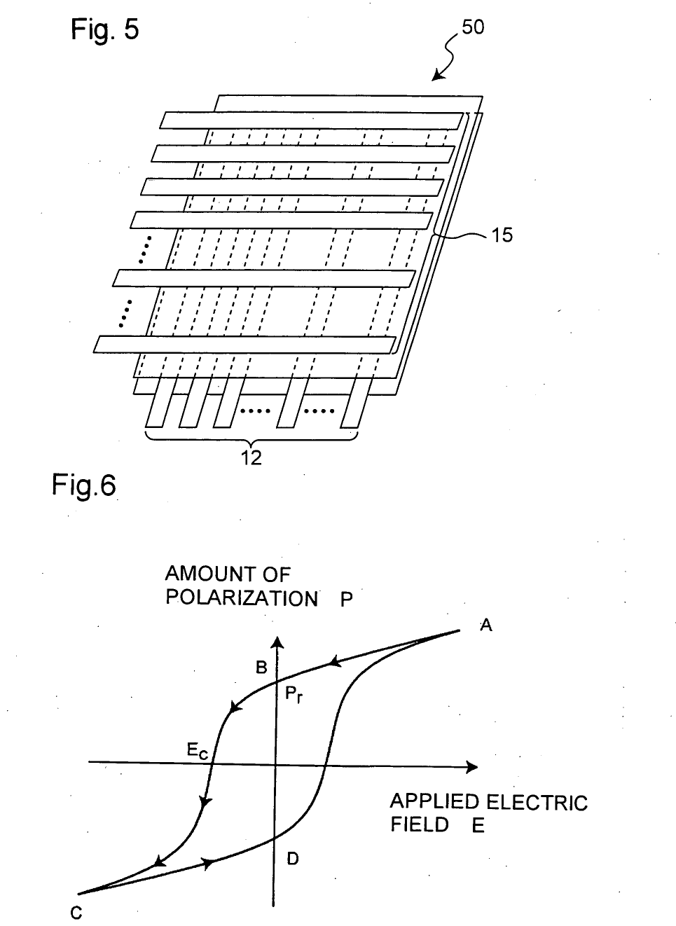

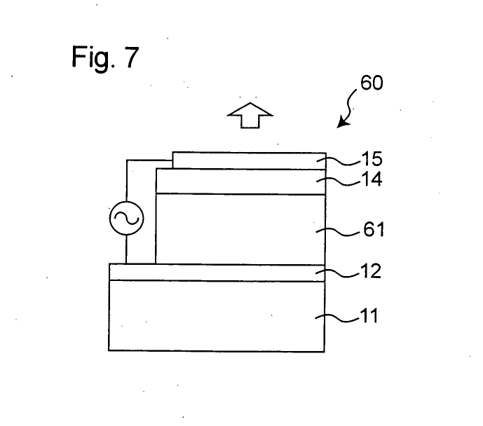

Referring to FIG. 5, the following description will discuss a display apparatus in accordance with a fourth embodiment of the present invention. FIG. 5 is a schematic plan view that shows a passive matrix display apparatus 50 constituted by opposing electrodes 12 and transparent electrodes 15 that are made orthogonal to each other. This display apparatus 50 is provided with an EL element array in which a plurality of EL elements relating to the first embodiment are two-dimensionally arranged. Moreover, a plurality of opposing electrodes 12, which are extended parallel to a first direction in parallel with the surface of the EL element array, and a plurality of transparent electrodes 15, which are extended parallel to a second direction that is orthogonal to the first direction, are installed therein. Furthermore, in this display apparatus 50, an external AC voltage is applied across the paired opposing electrode 12 and transparent electrode 15 so that one EL element is driven, and the resulting light emission is taken out from the transparent electrode 15 side. In accordance with this display apparatus 50, an organic ferroelectric material is used as an insulating layer for EL elements of each pixel. With this arrangement, it becomes possible to provide an EL element display apparatus which has high luminance, and is safe and inexpensive.

Moreover, in the case of forming a color display apparatus, light-emitting layers, which are separated into respective colors by using phosphors of respective colors of RGB, can be film-formed. Alternatively, light-emitting units of respective RGB colors, each constituted by an electrode/a light-emitting layer/an insulating layer/an electrode, may be stacked. Moreover, in another example of a color display apparatus, after a display apparatus, formed by mono-color or two-color light-emitting layers, has been prepared, the respective colors of RGB may be displayed by using color filters and/or color conversion filters.

The foregoing embodiments merely show examples, and the structures of the present invention are not intended to be limited by those structures.

### EXAMPLES

The following description will further discuss examples of the present invention in detail. However, the present invention is not intended to be limited by the examples described below.

Referring to FIG. 1, the following description will discuss an EL element in accordance with example 1 of the present invention. This EL element has the same structure as the EL element in accordance with the first embodiment; therefore, the description of the structure is omitted. In this EL element, a commercially available non-alkaline glass substrate was used as the substrate 11. Carbon paste was used as the opposing electrodes 12. With respect to the dielectric layer 13, a layer made from commercially available P (VDF/TrEF) (VDF 55 mol %) was used. With respect to the light-emitting layer 14, a ZnS thin film doped with Mn was used. With respect to the transparent layer 15, an ITO thin-film was used.

The following description will discuss the manufacturing method of this EL element. The EL element was manufactured through the following sequence of processes.
(a) A non-alkaline glass substrate was ultrasonic-wave-washed by using an alkaline detergent, water, acetone and isopropyl alcohol (IPA), and this was then taken out of the boiling IPA solution, and dried. Lastly, this was washed with UV/O₃. The resulting non-alkaline glass substrate was used as a substrate 11.
(b) Next, after carbon paste had been film-formed on the non-alkaline glass substrate 11 in a line pattern as the opposing electrodes 12 by using a screen printing method, this was dried so that a substrate with patterned electrodes was obtained.
(c) Next, a solution in which P(VDF/TrFE) had been dissolved in terpineol to be set to 30% by weight was prepared, and this was film-formed on the substrate with patterned electrodes by using a screen printing method. Thereafter, this was dried at a drying temperature of 120° C. The dried film thickness was set to 2 μm. A sample in which a dielectric thin film identical to the dielectric layer 13 was sandwiched by a pair of electrodes was prepared in a separate example, and its hysteresis characteristic was measured so that an amount of residual polarization of 5 μC/cm² was obtained.
(d) Next, by using a ZnS vapor-deposition source doped with Mn, a light-emitting layer 14 was formed on the dielectric layer 13 by using a vacuum vapor deposition method under a substrate temperature of 120° C. The film thickness was set to 0.5 μm.
(e) Next, by using an ITO target, a transparent electrode 15 was formed on the light-emitting layer 14 through an RF magnetron sputtering method. The thickness of the transparent electrodes 15 was set to 0.5 μm.

Through the above-mentioned processes, the EL element of example 1 was completed.

The EL element thus manufactured was evaluated by applying a sine-wave AC voltage of 200 V/500 Hz thereto, and a light-emitting luminance of 440 cd/m² was obtained.

### Example 2

The following description will discuss an EL element in accordance with example 2 of the present invention. In comparison with the EL element of example 1, this EL element is different in that in place of P(VDF/TrFE)(VDF 55 mol %), P(VDF/TrFE)(VDF 75 mol %) was used as the dielectric layer 13. Here, since the other constituent parts are virtually the same as those of the EL element of example 1, the description thereof is omitted. A sample in which a dielectric thin film identical to this dielectric layer was sandwiched by a pair of electrodes was prepared in a separate example, and its hysteresis characteristic was measured so that an amount of residual polarization of 7 μC/cm² was obtained. The EL element thus manufactured was evaluated by applying a sine-wave AC voltage of 200 V/500 Hz thereto, and a light-emitting luminance of 470 cd/m² was obtained.

### Example 3

The following description will discuss an EL element in accordance with example 3 of the present invention. In comparison with the EL element of example 1, this EL element is different in that in place of P (VDF/TrFE) (VDF 55 mol %), P (VDF/TeFE) (VDF 80 mol %) was used as the dielectric layer 13. Here, since the other constituent parts are virtually the same as those of the EL element of example 1, the description thereof is omitted. A sample in which a dielectric thin film identical to this dielectric layer was sandwiched by a pair of electrodes was prepared in a separate example, and its hysteresis characteristic was measured so that an amount of residual polarization of 4 μC/cm² was obtained. The EL element thus manufactured was evaluated by applying a sine-wave AC voltage of 200 V/500 Hz thereto, and a light-emitting luminance of 400 cd/m² was obtained.

### Example 4

The following description will discuss an EL element in accordance with example 4 of the present invention. In comparison with the EL element of example 1, this EL element is different in that in place of P (VDF/TrFE) (VDF 55 mol %), P (VF/TrFE) (VF 50 mol %) was used as the dielectric layer 13. Here, since the other constituent parts are virtually the same as those of the EL element of example 1, the description thereof is omitted. A sample in which a dielectric thin film identical to this dielectric layer was sandwiched by a pair of electrodes was prepared in a separate example, and its hysteresis characteristic was measured so that an amount of residual polarization of 4 μC/cm² was obtained. The EL element thus manufactured was evaluated by applying a sine-wave AC voltage of 200 V/500 Hz thereto, and a light-emitting luminance of 400 cd/m² was obtained.

### Comparative Example 1

The following description will discuss an EL element in accordance with comparative example 1. In comparison with the EL element of example 1, this EL element is different in that in place of P (VDF/TrFE) (VDF 55 mol %), polycyanophenylene sulfide (PCPS) was used as the dielectric layer. Here, since the other constituent parts are virtually the same as those of the EL element of example 1, the description thereof is omitted. A sample in which a dielectric thin film identical to this dielectric layer was sandwiched by a pair of electrodes was prepared in a separate example, and its hysteresis characteristic was measured so that an amount of residual polarization of 3 μC/cm² was obtained. The EL element thus manufactured was evaluated by applying a sine-wave AC voltage of 200 V/500 Hz thereto, and a light-emitting luminance of 310 cd/m² was obtained.

### Comparative Example 2

The following description will discuss an EL element in accordance with comparative example 2. In comparison with the EL element of example 1, this EL element is different in that in place of P (VDF/TrFE) (VDF 55 mol %), polyurea (PUA) was used as the dielectric layer. Here, since the other constituent parts are virtually the same as those of the EL element of example 1, the description thereof is omitted. A sample in which a dielectric thin film identical to this dielectric layer was sandwiched by a pair of electrodes was prepared in a separate example, and its hysteresis characteristic was measured so that an amount of residual polarization of 2 μC/cm² was obtained. The EL element thus manufactured was evaluated by applying a sine-wave AC voltage of 200 V/500 Hz thereto, and a light-emitting luminance of 240 cd/m² was obtained.

### Comparative Example 3

The following description will discuss an EL element in accordance with comparative example 3. In comparison with the EL element of example 1, this EL element is different in that in place of P (VDF/TrFE) (VDF 55 mol %), polyvinyl alcohol (PVA) serving as a paraelectric material was used as the dielectric layer. Here, since the other constituent parts are virtually the same as those of the EL element of example 1, the description thereof is omitted. A sample in which a dielectric thin film identical to this dielectric layer was sandwiched by a pair of electrodes was prepared in a separate example, and its hysteresis characteristic was measured so that an amount of residual polarization of 2 μC/cm² was obtained. The EL element thus manufactured was evaluated by applying a sine-wave AC voltage of 200 V/500 Hz thereto, and a light-emitting luminance of 180 cd/m² was obtained.

### Example 5

In comparison with the EL element of example 4, an EL element in accordance with example 5 of the present invention is different in that the film thickness of the dielectric layer 13 was changed to 3 μm. The other constituent parts are virtually the same as those of the EL element of example 4. The EL element thus manufactured was evaluated in the same manner as the above-mentioned examples, and a light-emitting luminance of 450 cd/m² was obtained.

### Example 6

In comparison with the EL element of example 4, an EL element in accordance with example 6 of the present invention is different in that the film thickness of the dielectric layer 13 was changed to 3 μm and in that the film thickness of the light-emitting layer 14 was changed to 0.15 μm. The other constituent parts are virtually the same as those of the EL element of example 4. The EL element thus manufactured was evaluated in the same manner as the above-mentioned examples, and a light-emitting luminance of 410 cd/m² was obtained.

### Example 7

In comparison with the EL element of example 4, an EL element in accordance with example 7 of the present invention is different in that the film thickness of the dielectric layer 13 was changed to 4 μm and in that the film thickness of the light-emitting layer 14 was changed to 0.2 μm. The other constituent parts are virtually the same as those of the EL element of example 4. The EL element thus manufactured was evaluated in the same manner as the above-mentioned examples, and a light-emitting luminance of 410 cd/m² was obtained.

### Example 8

In comparison with the EL element of example 4, an EL element in accordance with example 8 of the present invention is different in that the film thickness of the dielectric layer 13 was changed to 5 μm and in that the film thickness of the light-emitting layer 14 was changed to 0.3 μm. The other constituent parts are virtually the same as those of the EL element of example 4. The EL element thus manufactured was evaluated in the same manner as the above-mentioned examples, and a light-emitting luminance of 440 cd/m² was obtained.

### Example 9

In comparison with the EL element of example 4, an EL element in accordance with example 9 of the present invention is different in that the film thickness of the dielectric layer 13 was changed to 4 μm and in that the film thickness of the light-emitting layer 14 was changed to 0.3 μm. The other constituent parts are virtually the same as those of the EL element of example 1. The EL element thus manufactured was evaluated in the same manner as the above-mentioned examples, and a light-emitting luminance of 460 cd/m² was obtained.

### Comparative Example 4

In comparison with the EL element of example 4, an EL element in accordance with comparative example 4 is different in that the film thickness of the dielectric layer 13 was changed to 4 μm and in that the film thickness of the light-emitting layer 14 was changed to 0.15 μm. The other constituent parts are virtually the same as those of the EL element of example 4. The EL element thus manufactured had a thinner light-emitting layer and an increased light-emitting threshold voltage that allows light emission in comparison with that of example 4, etc., with the result that, when evaluated in the same manner as the above-mentioned examples, it provided a light-emitting luminance of 290 cd/m².

### Comparative Example 5

In comparison with the EL element of example 4, an EL element in accordance with comparative example 5 is different in that the film thickness of the dielectric layer 13 was changed to 5 μm and in that the film thickness of the light-emitting layer 14 was changed to 0.2 μm. The other constituent parts are virtually the same as those of the EL element of example 4. The EL element thus manufactured had a thinner light-emitting layer and an increased light-emitting threshold voltage in comparison with that of example 4, etc., with the result that, when evaluated in the same manner as the above-mentioned examples, it provided a light-emitting luminance of 300 cd/m².

### Comparative Example 6

In comparison with the EL element of example 1, an EL element in accordance with comparative example 6 is different in that the film thickness of the dielectric layer 13 was changed to 4 μm and in that the film thickness of the light-emitting layer 14 was changed to 0.15 μm. The other constituent parts are virtually the same as those of the EL element of example 1. The EL element thus manufactured had a thinner light-emitting layer and an increased light-emitting threshold voltage in comparison with that of example 1, etc., with the result that, when evaluated in the same manner as the above-mentioned examples, it provided a light-emitting luminance of 320 cd/m².

### INDUSTRIAL APPLICABILITY

By using a ferroelectric polymer material as a dielectric layer, an EL element and a display apparatus in accordance with the present invention make it possible to provide a product which has high luminance, and is safe and inexpensive. The product is effectively applied, in particular, to various light sources used for display devices, such as televisions, communication, illumination and the like.

1. A light-emitting element comprising:
a pair of electrodes, wherein at least one of the electrodes is transparent or translucent;
a light-emitting layer containing an inorganic phosphor material sandwiched between the electrodes; and
at least one layer of a dielectric layer made from a ferroelectric polymer material sandwiched between the electrodes in addition to the light-emitting layer.

2. The light-emitting element according to claim 1, wherein the dielectric layer is mainly composed of a ferroelectric polymer material having an amount of residual polarization of 4 μC/cm² or more.

3. The light-emitting element according to claim 1, wherein the ferroelectric polymer material is a fluorine-based polymer material.

4. The light-emitting element according to claim 1, wherein the light-emitting layer has a structure in which inorganic phosphor fine particles are dispersed in a binder.

5. The light-emitting element according to claim 1, wherein the light-emitting layer is an inorganic phosphor thin film.

6. The light-emitting element according to claim 1, wherein the light-emitting layer has a thickness of 1/20 or more of the thickness of the dielectric layer.

7. The light-emitting element according to claim 1, further comprising:
a supporting substrate that is made in contact with at least one of the electrodes and supports the electrode.

8. The light-emitting element according to claim 7, wherein the supporting substrate is a glass substrate.

9. The light-emitting element according to claim 7, wherein the supporting substrate is a transparent resin substrate having flexibility.

10. A display apparatus comprising:
a light-emitting element array in which the light-emitting elements according to any one of claims 1 to 9 are two-dimensionally arranged;
a plurality of x electrodes that are extended in parallel with one another in a first direction in parallel with the light-emitting face of the light-emitting element array, and
a plurality of y electrodes that are extended in parallel with one another in a second direction that is orthogonal to the first direction in parallel with the light-emitting face of the light-emitting element array.

11. The light-emitting element according to claim 1, wherein the dielectric layer has a thickness ranging from 1 μm to 10 μm.

12. The light-emitting element according to claim 1, wherein the dielectric layer has a thickness ranging from 2 μm to 5 μm.
